(19) United States
(12) Patent Application Publication
(10) Pub. No.: US 2025/0025905 A1
(43) Pub. Date: Jan. 23, 2025

(54) COATING DEVICE FOR ELECTRODE SUBSTRATE OF RECHARGEABLE BATTERY

(71) Applicant: SAMSUNG SDI CO., LTD., Yongin-si (KR)

(72) Inventors: Bumrae KIM, Yongin-si (KR); Dahyun KIM, Yongin-si (KR); Byonggon LEE, Yongin-si (KR)

(21) Appl. No.: 18/629,856

(22) Filed: Apr. 8, 2024

(30) Foreign Application Priority Data
Jul. 20, 2023 (KR) 10-2023-0094886

(51) Int. Cl. B05C 5/02; H01M 4/04

(52) U.S. Cl. CPC B05C 5/0254; H01M 4/0404

(57) ABSTRACT

A slot die coating device includes: a roll configured to continuously supply an electrode substrate; and a slot die configured to form an active material coating portion on the electrode substrate. The roll and the slot die form a first gap between each other at a center in a width direction of the electrode substrate and form a second gap that is greater than the first gap.

### CROSS-REFERENCE TO RELATED APPLICATION

The present application claims priority to and the benefit of Korean Patent Application No. 10-2023-0094886, filed on Jul. 20, 2023, in the Korean Intellectual Property Office, the entire disclosure of which is incorporated herein by reference.

### BACKGROUND

### 1. Field

Aspects of embodiments of the present disclosure relate to a coating device for an electrode substrate of a rechargeable battery.

### 2. Description of the Related Art

A rechargeable battery is a battery that is designed to be repeatedly charged and discharged, different from a primary battery. A small-capacity rechargeable battery may be used in a portable, small electronic device, such as a mobile phone, a laptop computer, or a camcorder, while a large-capacity rechargeable battery may be used as a power source for driving a motor of a hybrid vehicle or an electric vehicle.

A rechargeable battery generally includes an electrode assembly that performs charging and discharging, a package (e.g., a pouch or a can) that accommodates the electrode assembly, and an electrode terminal electrically connected to the electrode assembly to draw the electrode assembly out to the outside of the package. The electrode assembly may be a winding type electrode assembly in which a negative electrode plate and a positive electrode plate are wound on both sides of a separator that is interposed therebetween, or a stacking type electrode assembly in which a negative electrode plate and a positive electrode plate are stacked on both sides of a separator that is interposed therebetween.

An electrode plate process for manufacturing an electrode plate generally includes a mixing step of mixing an active material slurry, a coating step of applying the active material slurry to a coating portion of an electrode substrate, a pressing step of compressing the active material slurry on the coating portion, and a slitting step of cutting the electrode substrate.

Positive and negative electrode plates manufactured by the electrode plate process operate by facing each other. A ratio of the positive electrode to the negative electrode in the rechargeable battery is important to ensure safety. A capacity of the negative electrode should be larger than that of the positive electrode. In other words, a side reaction may be avoided or prevented if there is room for a lithium ion to be inserted into a negative electrode active material.

However, according to a conventional slot die coating method, an amount of a coating on an edge portion is relatively small. Lack of coating may increase resistance by increasing a face-to-face distance between the positive electrode and the negative electrode, and safety may be deteriorated due to a phenomenon (e.g., a reversal phenomenon) caused by an imbalance in face-to-face capacity. In other words, a shape for maintaining the face-to-face distance and a uniform amount of an active material across all regions is desirable.

An amount of flow may be controlled through rheology control and a change in a shape of a spacer inside a slot die. However, there is a difference between a sliding shape of the coating edge portion and the amount of the active material.

### SUMMARY

Embodiments of the present disclosure provide a coating device for an electrode substrate of a rechargeable battery that reduces or minimizes a difference in an application amount of an active material between a coating central portion and a coating edge portion by controlling a shape of the coating edge portion and the application amount of the active material.

Other embodiments of the present disclosure provide a coating device for an electrode substrate of a rechargeable battery that ensures a safe face-to-face ratio between a positive electrode and a negative electrode and maintains a constant face-to-face distance by controlling a shape of a coating edge portion and an application amount of an active material.

A slot die coating device, according to an embodiment of the present disclosure, includes: a roll configured to continuously supply an electrode substrate; and a slot die configured to form an active material coating portion on the electrode substrate. The roll and the slot die form a first gap between each other at a center in a width direction of the electrode substrate and form a second gap that is greater than the first gap.

The first gap may be between a rip in the slot die and the electrode substrate on the roll.

The roll may have a non-corresponding portion extending beyond the slot die, and the non-corresponding portion corresponding to both ends of the rip in the slot die may have a small diameter portion.

The second gap may be formed between an end portion of the rip in the slot die and the small diameter portion of the roll.

The small diameter portion may have: a truncated circular cone surface that is inclined away from an end portion of the rip of the slot die; and a cylindrical face that extends from the truncated circular cone surface in an axial direction of the roll.

The small diameter portion may have: a truncated circular cone surface formed as a convex curved surface inclined smoothly away from an end portion of the rip in the slot die and then rapidly inclined; and a cylindrical surface extending from the truncated circular cone surface in an axial direction of the roll.

The small diameter portion may have: a truncated circular cone surface formed as a concave curved surface inclined rapidly away from an end portion of the rip in the slot die and then smoothly inclined; and a cylindrical surface extending from the truncated circular cone surface in an axial direction of the roll.

The roll may have a non-corresponding portion longer than the slot die, and both ends of the rip in the slot die may have an expansion rip corresponding to the roll adjacent to the non-corresponding portion.

The second gap may be formed between the expansion rip at both ends of the rip in the slot die and the roll adjacent to the non-corresponding portion.

The expansion rip may have: an inclined portion inclined away from the roll; and a planar portion extending from the inclined portion in an axial direction of the roll.

The expansion rip may have: an inclined portion formed as a convex curved surface inclined smoothly away from the roll and then rapidly inclined; and a planar portion extending from the inclined portion in an axial direction of the roll.

The expansion rip may have: an inclined portion formed as a concave curved surface inclined rapidly away from the roll and then smoothly inclined; and a planar portion extending from the inclined portion in an axial direction of the roll . . .

Embodiments of the present disclosure may form a first gap between a roll and a slot die at a center, in a width direction, of an electrode substrate and may form a second gap that is larger than the first gap at both ends, in the width direction, of the electrode substrate so that a shape of a coating edge portion and an application amount of an active material are controlled. Therefore, embodiments of the present disclosure may reduce or minimize a difference in the application amount of the active material between a coating central portion and a coating edge portion.

Embodiments of the present disclosure may form, in the center of the width direction of the electrode substrate, a first gap and may form, at both ends in the width direction of the electrode substrate, a second gap that is larger than the first gap to control a shape of a coating edge portion and an application amount of the active material to ensure a safe face-to-face ratio between a positive electrode and a negative electrode and to maintain a constant face-to-face distance.

### BRIEF DESCRIPTION OF THE DRAWINGS

FIG. 1 is a cross-sectional view of a coating device for an electrode substrate of a rechargeable battery according to an embodiment of the present disclosure.

FIG. 2 includes various views showing application of an active material to an electrode substrate supplied by a roll show in FIG. 1.

FIG. 3 is a state diagram illustrating a first gap and a second gap between a roll and a slot die in a coating device for an electrode substrate of a rechargeable battery according to another embodiment of the present disclosure.

FIG. 4 is a state diagram illustrating a first gap and a second gap between a roll and a slot die in a coating device for an electrode substrate of a rechargeable battery according to another embodiment of the present disclosure.

FIG. 5 is a state diagram showing application of an active material to an electrode substrate supplied by a roll with a slot die in a coating device for an electrode substrate of a rechargeable battery according to another embodiment of the present disclosure.

FIG. 6 is a state diagram illustrating a first gap and a second gap between a roll and a slot die in a coating device for an electrode substrate of a rechargeable battery according to another embodiment of the present disclosure.

FIG. 7 is a state diagram illustrating a first gap and a second gap between a roll and a slot die in a coating device for an electrode substrate of a rechargeable battery according to another embodiment of the present disclosure.

### DETAILED DESCRIPTION

The present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodimen “s.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

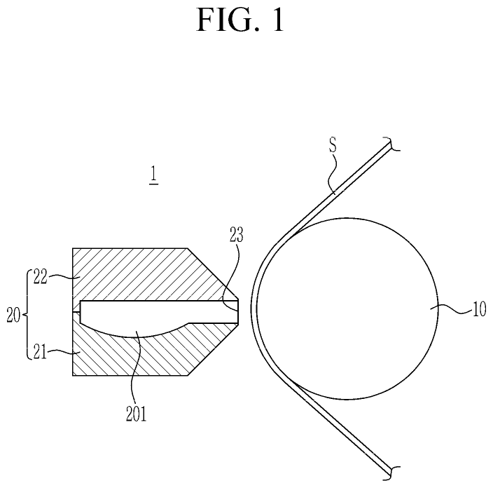

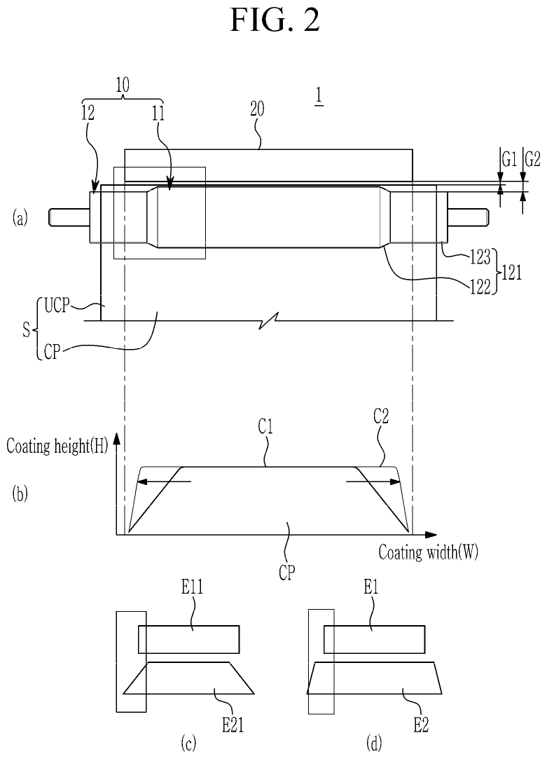

FIG. 1 is a cross-sectional view of a coating device for an electrode substrate of a rechargeable battery according to an embodiment of the present disclosure, and FIG. 2 is a plan view (a) of a step of applying an active material to an electrode substrate supplied by a roll shown in FIG. 1 by using a slot die, a cross-sectional view (b) of a shape of the applied active material coating portion, and a cross-sectional view (c or d) of a portion at where a negative electrode and a positive electrode face each other.

Referring to FIG. 1 and FIG. 2, the coating device 1 for the electrode substrate of the rechargeable battery according to an embodiment may include a roll 10 that continuously supplies an electrode substrate S and a slot die 20 configured to form an active material coating portion CP at (or on) the electrode substrate S. The roll 10 may move the electrode substrate S toward the slot die 20 to coat an active material while rotating and may then move the electrode substrate S away from the slot die 20.

For example, the slot die 20 may include a first block 21, a second block 22, and a shim member (e.g., a shim) installed between the first block 21 and the second block 22. The first block 21, the second block 22, and the shim member installed between the first block 21 and the second block 22 may be fastened with a fastening member to form the slot die for coating an active material slurry.

The first block 21 may include a chamber 201 that stores (e.g., temporarily stores) the supplied active material slurry to uniformly supply the stored active material slurry in a width direction. A supply portion (e.g., a supply unit) may be connected to a lower portion of the first block 21 to supply the active material slurry to the chamber 201. The first and second blocks 21 and 22, coupled to each other, may form a rip (or an opening or slot) 23 for discharging the active material slurry.

The slot die 20 may temporarily accommodate the active material slurry supplied through the supply portion in the chamber 201 before discharging the accommodated active material slurry through the rip 23 so that the slot die 20 applies a uniform or substantially uniform amount of the active material slurry to the electrode substrate S advancing forward of the rip 23 in the width direction. Therefore, the coated portion CP to which the active material slurry is applied and an uncoated portion UCP at both sides of (e.g., at opposite sides of) the coated portion CP at where the active material slurry is not applied and at where the electrode substrate S is exposed are formed at (or on) the electrode substrate S.

Based on a width direction of the electrode substrate S, in the coated portion CP, a coating central portion C1 may be formed at a center in the width direction and a coating edge portion C2 may be formed at both ends of the coated portion CP in the width direction that are at both sides of the coating central portion C1.

The illustrated embodiment may control a shape of the coating edge portion C2 and an application amount of the coating edge portion C2 to reduce a difference in the application amount between the coating central portion C1 and the coating edge portion C2 so that stability of the rechargeable battery is ensured by making a face-to-face distance between the positive electrode and the negative electrode uniform or substantially uniform.

The roll 10 and the slot die 20 may form a first gap G1 between the roll 10 and the slot die 20 in a moving direction of the electrode substrate S at a center of the width direction (e.g., an x-axis direction) of the electrode substrate S and may form a second gap G2 that is larger than the first gap G1 at both ends of the width direction. The first gap G1 and the second gap G2 may be set between the rip 23 in the slot die 20 and the electrode substrate S progressing on (or along) the roll 10.

The first and second gaps G1 and G2 may allow the application amount of the active material to be constant or substantially constant when the active material slurry of each of the positive and negative electrodes is coated on the electrode substrate S. For example, the first gap G1 may maintain the application amount and a coating height (H) relatively constant in the coating central portion C1, and the second gap G2 may maintain the application amount of the coating edge portion C2 the same level or substantially the same level as that of the coating central portion C1.

Therefore, the application amount and the coating height (H) of the active material slurry may be uniform or substantially uniform in a region at where the positive electrode E1 and the negative electrode E2 face each other. For example, the application amount and the coating height (H) of the active material slurry in the region at where the positive electrode E1 and the negative electrode E2 face each other in the illustrated embodiment (d) may be more uniform than the application amount and the coating height (H) of the active material slurry in a region at where a positive electrode E11 and a negative electrode E21 face each other in a conventional example (c) so that the stability of the rechargeable battery is improved.

Referring to FIG. 2, for example, the roll 10 may have a corresponding portion 11 corresponding to the slot die 20 and a non-corresponding portion 12 that is formed longer than (e.g., that is outside of or beyond) the slot die 20 so as to not correspond to the slot die 20.

The slot die 20 and the roll 10 may form the first gap G1 between each other in the corresponding portion 11. For example, in the corresponding portion 11, the rip 23 in the slot die 20 and the electrode substrate S may form the first gap G1 between each other. The first gap G1 may form the coating central portion C1 by making the application amount of the active material slurry constant or substantially constant in the corresponding portion 11.

The non-corresponding portion 12 of the roll 10 may have a small diameter portion 121 having a diameter smaller than a diameter of the corresponding portion 11. The small diameter portion 121 may be formed at the non-corresponding portion 12 corresponding to both ends of the rip 23 in the slot die 20. For example, the small diameter portion 121 may start from a connection portion between the corresponding portion 11 and the non-corresponding portion 12 and may be formed throughout the non-corresponding portion 12.

As an example, the small diameter portion 121 may have a truncated circular cone surface 122 that is inclined away from an end portion of the rip 23 of the slot die 20 and a cylindrical surface 123 that is connected to (e.g., that extends from) the truncated circular cone surface 122 in an axial direction of the roll 10.

The slot die 20 and the roll 10 may form the second gap G2 between each other in the non-corresponding portion 12. For example, in the small diameter portion 121 of the non-corresponding portion 12, the rip 23 in the slot die 20 and the electrode substrate S may form the second gap G2 between each other. The second gap G2 may form the coating edge portion C2 by increasing the application amount of the active material slurry in the non-corresponding portion 12 compared with that in the coating central portion C1.

The truncated circular cone surface 122 in the small diameter portion 121 may gradually increase the first gap G1 to the second gap G2 to prevent a rapid increase in the application amount on the cylindrical surface 123. Therefore, the truncated circular cone surface 122 connecting the corresponding portion 11 and the cylindrical surface 123 may provide (or may form) a gradual increase in the application amount in each of the coating central portion C1 and the coating edge portion C2.

Due to the first and second gaps G1 and G2 formed by the truncated circular cone surface 122 and the cylindrical surface 123 of the small diameter portion 121, the application amount of the active material slurry in the coating edge portion C2 may be increased compared with that in the coating central portion C1.

The coating central portion C1 and the coating edge portion C2 may form the same level of application amount and the same coating height (H). For example, the application amount and the coating height (H) of the active material slurry may be uniform or substantially uniform in the region at where the positive electrode E1 and the negative electrode E2 face each other.

Therefore, when the electrode substrate S is used in an electrode assembly of a rechargeable battery, a face-to-face distance and a face-to-face capacity between the positive and negative electrodes in the rechargeable battery may be constant. Accordingly, resistance may be reduced at the portion where the negative electrode and the positive electrode face each other and safety may be ensured.

Hereinafter, various embodiments of the present disclosure will be described. A description of an embodiment that is the same as the above-described embodiment may be omitted, and a description of an embodiment that is different from the above-described embodiment will be primarily described.

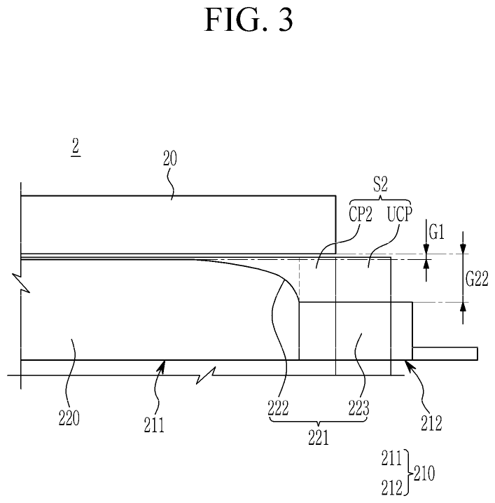

FIG. 3 is a state diagram illustrating a first gap and a second gap between a roll and a slot die in a coating device for an electrode substrate of a rechargeable battery according to another embodiment of the present disclosure. Referring to FIG. 3, in the coating device 2 according to this embodiment, a small diameter portion 221 may have a truncated circular cone surface 222 with a convex curved surface that is smoothly inclined away from an end portion of the rip 23 in the slot die 20 and then rapidly inclines and a cylindrical surface 223 connected to (e.g., extending from) the truncated circular cone surface 222 in an axial direction of the roll 210.

In a non-corresponding portion 212, the slot die 20 and the roll 210 may form a second gap G22 between each other. For example, in the small diameter portion 221 of the non-corresponding portion 212, the rip 23 in the slot die 20 and the electrode substrate S2 may form the second gap G22 between each other. The second gap G22 may form the coating edge portion C2 shown in FIG. 2 by increasing the application amount of the active material slurry in the non-corresponding portion 212 compared with that in the coating central portion C1 shown in FIG. 2.

The truncated circular cone surface 222 in the small diameter portion 221 may gently (e.g., smoothly or slowly) increase the first gap G1 toward the second gap G22 and then may rapidly increase to the second gap G22 to prevent a rapid increase in the application amount on the cylindrical surface 223. Therefore, the truncated circular cone surface 222 connecting (or extending between) a corresponding portion 211 and the cylindrical surface 223 may provide a gradual increase in the application amount in each of the coating central portion C1 and the coating edge portion C2.

Due to the first and second gaps G1 and G22 formed by the truncated circular cone surface 222 and the cylindrical surface 223 of the small diameter portion 221, the application amount of the active material slurry in the coating edge portion C2 may be increased compared to that in the coating central portion C1.

The coating central portion C1 and the coating edge portion C2 may form the same level of application amount and the same coating height (H). For example, the application amount and the coating height (H) of the active material slurry may be uniform or substantially uniform in the region at where the positive electrode E1 and the negative electrode E2 face each other.

Therefore, when the electrode substrate S2 is used in an electrode assembly of a rechargeable battery, a face-to-face distance and a face-to-face capacity between the positive and negative electrodes in the rechargeable battery may be constantly ensured. Accordingly, resistance may be reduced at the portion at where the negative electrode and the positive electrode face each other and safety may be ensured.

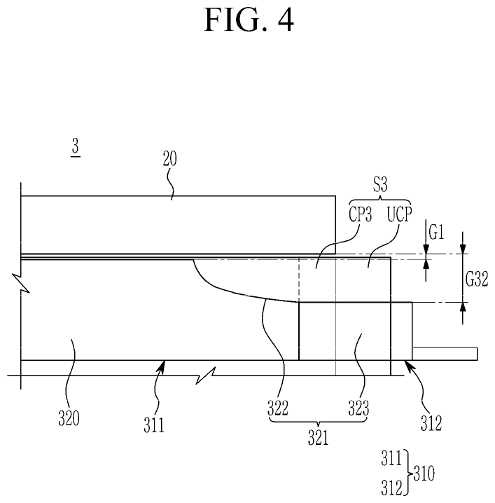

FIG. 4 is a state diagram illustrating a first gap and a second gap between a roll and a slot die in a coating device for an electrode substrate of a rechargeable battery according to another embodiment of the present disclosure. Referring to FIG. 4, in the coating device 3 according to this embodiment, a small diameter portion 321 may have a truncated circular cone surface 322 with a concave curved surface that inclines rapidly away from an end portion of the rip 23 in the slot die 20 and then smoothly inclines and a cylindrical surface 323 connected to (e.g., extending from) the truncated circular cone surface 322 in an axial direction of the roll 310.

In a non-corresponding portion 312, the slot die 20 and the roll 310 may form a second gap G32 between each other. For example, in the small diameter portion 321 of the non-corresponding portion 312, the rip 23 in the slot die 20 and the electrode substrate S3 may form the second gap G32 between each other. The second gap G32 may form the coating edge portion C2 shown in FIG. 2 by increasing the application amount of the active material slurry in the non-corresponding portion 312 compared with that in the coating central portion C1 shown in FIG. 2.

The truncated circular cone surface 322 in the small diameter portion 321 may rapidly increase the first gap G1 toward the second gap G32 and then may gently increase the gap to the second gap G32 to prevent a rapid increase in the application amount on the cylindrical surface 323. Therefore, the truncated circular cone surface 322 connecting a corresponding portion 311 and the cylindrical surface 323 may provide a gradual increase in the application amount in each of the coating central portion C1 and the coating edge portion C2.

Due to the first and second gaps G1 and G32 formed by the truncated circular cone surface 322 and the cylindrical surface 323 of the small diameter portion 321, the application amount of the active material slurry in the coating edge portion C2 may be increased compared with that in the coating central portion C1.

The coating central portion C1 and the coating edge portion C2 may form the same level of application amount and the same coating height (H). For example, the application amount and the coating height (H) of the active material slurry may be uniform or substantially uniform in the region at where the positive electrode E1 and the negative electrode E2 face each other.

Therefore, when the electrode substrate S3 is used in an electrode assembly of a rechargeable battery, a face-to-face distance and a face-to-face capacity between the positive and negative electrodes in the rechargeable battery may be constantly ensured. For this reason, resistance may be reduced at the portion at where the negative electrode and the positive electrode face each other and safety may be ensured.

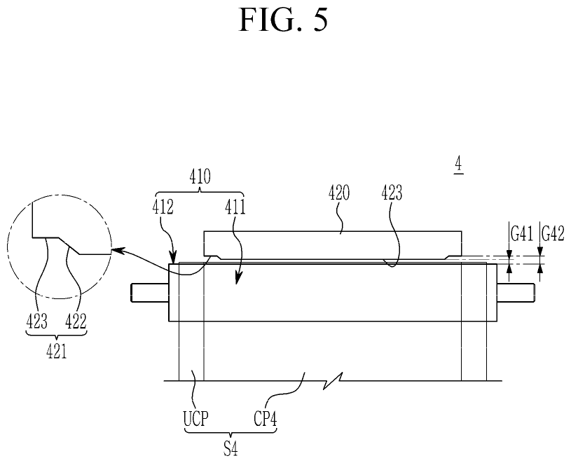

FIG. 5 is a plan view illustrating application of an active material to an electrode substrate supplied by a roll with a slot die in a coating device for an electrode substrate of a rechargeable battery according to another embodiment of the present disclosure. Referring to FIG. 5, in the coating device 4 according to this embodiment, the roll 410 may have a corresponding portion 411 corresponding to the slot die 420 and a non-corresponding portion 412 that is formed longer than the slot die 420 so as to not correspond to the slot die 420.

In the corresponding portion 411, the slot die 420 and the roll 410 may form a first gap G41 between each other. For example, in the corresponding portion 411, a rip 403 in the slot die 420 and the electrode substrate S4 may form the first gap G41 between each other. The first gap G41 may form the coating central portion C1 shown in FIG. 2 by making the application amount of the active material slurry constant in the corresponding portion 411.

Both ends of the rip 403 in the slot die 420 may have an expansion rip (e.g., an expanded or enlarged opening) 421 corresponding to the roll 410 adjacent to the non-corresponding portion 412. The expansion rip 421 may start from a connection portion between the corresponding portion 411 and the non-corresponding portion 412 to be formed at a portion of the corresponding portion 411.

A second gap G42 may be formed between the expansion rip 421 provided at both ends of the rip 403 in the slot die 420 and the corresponding portion 411 of the roll 410 adjacent to the non-corresponding portion 412. The second gap G42 may form the coating edge portion C2 by increasing the application amount of the active material slurry at both ends of the corresponding portion 411 adjacent to the non-corresponding portion 412 compared with that in the coating central portion C1.

As an example, the expansion rip 421 may have an inclined portion 422 that is inclined away from the roll 410 and a planar portion 423 that is connected to (or extends from) the inclined portion 422 in an axial direction of the roll 410. The inclined portion 422 in the expansion rip 421 may gradually increase the first gap G41 to the second gap G42 to prevent a rapid increase in the application amount in the planar portion 423. Therefore, the inclined portion 422 connecting the corresponding portion 411 and the planar portion 423 may provide a gradual increase in the application amount in each of the coating central portion C1 and the coating edge portion C2.

Due to the first and second gaps G41 and G42 formed by the inclined portion 422 and the planar portion 423 of the expansion rip 421, the application amount of the active material slurry in the coating edge portion C2 may be increased compared with that in the coating central portion C1.

The coating central portion C1 and the coating edge portion C2 may form the same level of application amount and the same coating height (H) (see, e.g., FIG. 2). For example, the application amount and the coating height (H) of the active material slurry may be uniform or substantially uniform in the region at where the positive electrode E1 and the negative electrode E2 face each other.

Therefore, when the electrode substrate S4 is used in an electrode assembly of a rechargeable battery, a face-to-face distance and a face-to-face capacity between the positive and negative electrodes in the rechargeable battery may be constantly ensured. Accordingly, resistance may be reduced at the portion at where the negative electrode and the positive electrode face each other and safety may be ensured.

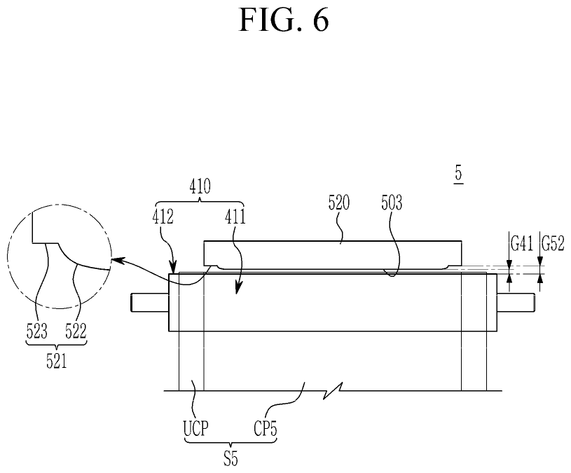

FIG. 6 is a state diagram illustrating a first gap and a second gap between a roll and a slot die in a coating device for an electrode substrate of a rechargeable battery according to another embodiment of the present disclosure. Referring to FIG. 6, in the coating device 5 according to this embodiment, the roll 410 may have the corresponding portion 411 corresponding to the slot die 520 and the non-corresponding portion 412 that is formed longer than the slot die 520 so as to not correspond to the slot die 520.

In the corresponding portion 411, the slot die 520 and the roll 410 may form the first gap G41 between each other. For example, in the corresponding portion 411, a rip 503 in the slot die 520 and the electrode substrate S5 may form the first gap G41 between each other. The first gap G41 may form the coating central portion C1 shown in FIG. 2 by making the application amount of the active material slurry constant in the corresponding portion 411.

Both ends of the rip 503 in the slot die 520 may have an expansion rip 521 corresponding to the roll 410 adjacent to the non-corresponding portion 412. The expansion rip 521 may start from a connection portion between the corresponding portion 411 and the non-corresponding portion 412 to be formed at a portion of the corresponding portion 411.

A second gap G52 may be formed between the expansion rip 521 provided at both ends of the rip 503 in the slot die 520 and the corresponding portion 411 of the roll 410 adjacent to the non-corresponding portion 412. The second gap G52 may form the coating edge portion C2 by increasing the application amount of the active material slurry at both ends of the corresponding portion 411 adjacent to the non-corresponding portion 412 compared with that in the coating central portion C1.

As an example, the expansion rip 521 may have an inclined portion 522 formed as a convex curved surface that inclines smoothly away from the roll 410 and then rapidly inclines and a planar portion 523 connected to (e.g., extending from) the inclined portion 522 in the axial direction of the roll 410. The inclined portion 522 in the expansion rip 521 may gradually increase the first gap G41 to the second gap G52 to prevent a rapid increase in the application amount in the planar portion 523. Accordingly, the inclined portion 522 connecting the corresponding portion 411 and the planar portion 523 may provide a gradual increase in the application amount in each of the coating central portion C1 and the coating edge portion C2.

Due to the first and second gaps G41 and G52 formed by the inclined portion 522 and the planar portion 523 of the expansion rip 521, the application amount of the active material slurry in the coating edge portion C2 may be increased compared with that in the coating central portion C1.

The coating central portion C1 and the coating edge portion C2 may form the same level of application amount and the same coating height (H) (see, e.g., FIG. 2). For example, the application amount and the coating height (H) of the active material slurry may be uniform or substantially uniform in the region at where the positive electrode E1 and the negative electrode E2 face each other.

Therefore, when the electrode substrate S5 is used in an electrode assembly of a rechargeable battery, a face-to-face distance and a face-to-face capacity between the positive and negative electrodes in the rechargeable battery may be constantly ensured. Accordingly, resistance may be reduced at the portion at where the negative electrode and the positive electrode face each other and safety may be ensured.

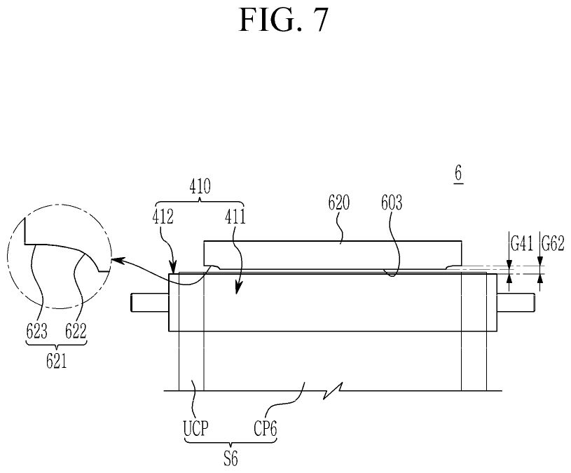

FIG. 7 is a state diagram illustrating a first gap and a second gap with a roll and a slot die in a coating device for an electrode substrate of a rechargeable battery according to another embodiment of the present disclosure. Referring to FIG. 7, in the coating device 6 according to this embodiment, the roll 410 may have the corresponding portion 411 corresponding to the slot die 620 and the non-corresponding portion 412 that is formed longer than the slot die 620 so as to not correspond to the slot die 620.

In the corresponding portion 411, the slot die 620 and the roll 410 may form the first gap G41 between each other. For example, in the corresponding portion 411, a rip 603 in the slot die 620 and the electrode substrate S6 may form the first gap G41 between each other. The first gap G41 may form the coating central portion C1 shown in FIG. 2 by making the application amount of the active material slurry constant or substantially constant in the corresponding portion 411.

Both ends of the rip 603 in the slot die 620 may have an expansion rip 621 corresponding to the roll 410 adjacent to the non-corresponding portion 412. The expansion rip 621 may start from a connection portion between the corresponding portion 411 and the non-corresponding portion 412 to be formed at a portion of the corresponding portion 411.

A second gap G62 may be formed between the expansion rip 621 provided at both ends of the rip 603 in the slot die 620 and the corresponding portion 411 of the roll 410 adjacent to the non-corresponding portion 412. The second gap G62 may form the coating edge portion C2 by increasing the application amount of the active material slurry at both ends of the corresponding portion 411 adjacent to the non-corresponding portion 412 compared with that in the coating central portion C1.

As an example, the expansion rip 621 may have an inclined portion 622 formed as a convex curved surface that inclines smoothly away from the roll 410 and then rapidly inclines and a planar portion 623 connected to (e.g., extending from) the inclined portion 622 in the axial direction of the roll 410. The inclined portion 622 in the expansion rip 621 may gradually increase the first gap G41 to the second gap G62 to prevent a rapid increase in the application amount in the planar portion 623. Accordingly, the inclined portion 622 connecting the corresponding portion 411 and the planar portion 623 may provide a gradual increase in the application amount in each of the coating central portion C1 and the coating edge portion C2.

Due to the first and second gaps G41 and G62 formed by the inclined portion 622 and the planar portion 623 of the expansion rip 621, the application amount of the active material slurry in the coating edge portion C2 may be increased compared with that in the coating central portion C1.

The coating central portion C1 and the coating edge portion C2 may form the same level of application amount and the same coating height (H) (see, e.g., FIG. 2). For example, the application amount and the coating height (H) of the active material slurry may be uniform or substantially uniform in the region at where the positive electrode E1 and the negative electrode E2 face each other.

Therefore, when the electrode substrate S6 is used in an electrode assembly of a rechargeable battery, a face-to-face distance and a face-to-face capacity between the positive and negative electrodes in the rechargeable battery may be constantly ensured. Accordingly, resistance may be reduced at the portion at where the negative electrode and the positive electrode face each other and safety may be ensured.

While the present disclosure has been described in connection with what is presently considered to be practical embodiments, it is to be understood that the present disclosure is not limited to the disclosed embodiments but, on the contrary, is intended to cover various modifications and equivalent arrangements included within the spirit and scope of the appended claims.

Description of Some Reference Symbols

| | |
|---|---|
| 1, 2, 3, 4, 5, 6: coating device | 10, 210, 310, 410: roll |
| 11, 211: corresponding portion | |
| 12, 212: non-corresponding portion | |
| 20: slot die | 21: first block |
| 22: second block | 23, 423: rip |
| 121, 221, 321: small diameter portion | |
| 122, 222, 322: truncated circular cone surface | |
| 123, 223, 323: cylindrical surface | 201: chamber |
| 403, 503, 603: rip | 410: roll |
| 411: corresponding portion | 412: non-corresponding portion |
| 420: slot die | 421: expansion rip |
| 422: inclined portion | 423: planar portion |
| 520: slot die | 521: expansion rip |
| 522: inclined portion | 523: planar portion |
| 620: slot die | 621: expansion rip |
| 622: inclined portion | 623: planar portion |
| C1: coating central portion | C2: coating edge portion |
| CP, CP2, CP3: coated portion | CP4: coated portion |
| CP5: coated portion | CP6: coated portion |
| G1: first gap | G2, G22, G32: second gap |
| G41: first gap | G42: second gap |
| G52: second gap | G62: second gap |
| H: coating height | S, S2, S3, S4, S5, S6: electrode substrate |
| UCP: uncoated portion | W: coating width |

What is claimed is:

1. A slot die coating device comprising
a roll configured to continuously supply an electrode substrate; and
a slot die configured to form an active material coating portion on the electrode substrate,
wherein the roll and the slot die form a first gap between each other at a center in a width direction of the electrode substrate and form a second gap that is greater than the first gap.

2. The slot die coating device as claimed in claim 1, wherein the first gap is between a rip in the slot die and the electrode substrate on the roll.

3. The slot die coating device as claimed in claim 2, wherein the roll has a non-corresponding portion extending beyond the slot die, and
wherein the non-corresponding portion corresponding to both ends of the rip in the slot die has a small diameter portion.

4. The slot die coating device as claimed in claim 3, wherein the second gap is formed between an end portion of the rip in the slot die and the small diameter portion of the roll.

5. The slot die coating device as claimed in claim 3, wherein the small diameter portion has:
a truncated circular cone surface that is inclined away from an end portion of the rip of the slot die; and
a cylindrical face that extends from the truncated circular cone surface in an axial direction of the roll.

6. The slot die coating device as claimed in claim 3, wherein the small diameter portion has:
a truncated circular cone surface formed as a convex curved surface inclined smoothly away from an end portion of the rip in the slot die and then rapidly inclined; and
a cylindrical surface extending from the truncated circular cone surface in an axial direction of the roll.

7. The slot die coating device as claimed in claim 3, wherein the small diameter portion has:
a truncated circular cone surface formed as a concave curved surface inclined rapidly away from an end portion of the rip in the slot die and then smoothly inclined; and
a cylindrical surface extending from the truncated circular cone surface in an axial direction of the roll.

8. The slot die coating device as claimed in claim 2, wherein the roll has a non-corresponding portion longer than the slot die, and
wherein both ends of the rip in the slot die have an expansion rip corresponding to the roll adjacent to the non-corresponding portion.

9. The slot die coating device as claimed in claim 8, wherein the second gap is formed between the expansion rip at both ends of the rip in the slot die and the roll adjacent to the non-corresponding portion.

10. The slot die coating device as claimed in claim 8, wherein the expansion rip has:
an inclined portion inclined away from the roll; and
a planar portion extending from the inclined portion in an axial direction of the roll.

11. The slot die coating device as claimed in claim 8, wherein the expansion rip has:
an inclined portion formed as a convex curved surface inclined smoothly away from the roll and then rapidly inclined; and
a planar portion extending from the inclined portion in an axial direction of the roll.

12. The slot die coating device as claimed in claim 8, wherein the expansion rip has:
an inclined portion formed as a concave curved surface inclined rapidly away from the roll and then smoothly inclined; and
a planar portion extending from the inclined portion in an axial direction of the roll.
